(19) United States
(12) Patent Application Publication
(10) Pub. No.: US 2011/0164515 A1
(43) Pub. Date: Jul. 7, 2011

(54) COMMUNICATION METHOD

(75) Inventors: Jisoo Park, Daejeon (KR); Namsuk Lee, Daejeon (KR); Yong Seouk Choi, Daejeon (KR); Sook Jin Lee, Daejeon (KR)

(73) Assignee: Electronics and Telecommunications Research Institute, Daejeon (KR)

(21) Appl. No.: 12/980,746

(22) Filed: Dec. 29, 2010

(30) Foreign Application Priority Data
Dec. 29, 2009 (KR) 10-2009-0132580
Dec. 24, 2010 (KR) 10-2010-0134919

(51) Int. Cl. H04W 72/04; H04W 4/00; H04L 12/26

(52) U.S. Cl. 370/252; 370/328; 370/329

(57) ABSTRACT

A base station transmits an uplink resource allocation message including a first frame offset and a second frame offset to a mobile station. The mobile station transmits an uplink packet to the base station in a frame corresponding to a first frame index determined by using the first frame offset. The base station transmits a feedback corresponding to the uplink packet to the mobile station in a frame corresponding to a second frame index determined by using the second frame offset. If the feedback is negative, the mobile station retransmits the uplink packet to the base station in a frame corresponding to a third frame index determined by using the first frame offset.

### CROSS-REFERENCE TO RELATED APPLICATION

This application claims priority to and the benefit of Korean Patent Application Nos. 10-2009-0132580 filed in the Korean Intellectual Property Office on Dec. 29, 2009, and 10-2010-0134919 filed in the Korean Intellectual Property Office on Dec. 24, 2010, the entire contents of which are incorporated herein by reference.

### BACKGROUND OF THE INVENTION

(a) Field of the Invention

The present invention relates to a communication method. In particular, the present invention relates to timing regarding transmission of packets or messages.

(b) Description of the Related Art

A wireless mobile communication system mainly performs communication using a communication frame.

A communication frame will be described below with reference to FIGS. 1 and 2.

FIG. 1 illustrates a communication frame of a frequency division duplex (FDD) scheme in the conventional art.

As illustrated in FIG. 1, a communication frame of the frequency division duplex scheme includes F downlink subframes and F uplink subframes. F corresponds to the number of subframes of one communication frame.

Downlink subframe indices 0 to F-1 are assigned to the F downlink subframes, and uplink subframe indices 0 to F-1 are assigned to the F uplink subframes.

FIG. 2 illustrates a communication frame of a time division duplex (TDD) scheme in the conventional art.

As illustrated in FIG. 2, a communication frame of a time division duplex scheme frequency scheme includes D downlink subframes and U uplink subframes.

Downlink subframe indices 0 to D-1 are assigned to the D downlink subframes, and uplink subframe indices 0 to U-1 are assigned to the U uplink subframes.

To achieve high speed data packet transmission, low delay, and transmission reliability, mobile communication systems make use of a hybrid automatic repeat request (HARQ) scheme that incorporates a forward error correction (FEC) scheme and an automatic repeat request (ARQ) scheme.

The retransmission scheme of the HARQ may be classified into a synchronous HARQ scheme and an asynchronous HARQ scheme depending on the transmission timing of a retransmission packet. In the synchronous HARQ scheme, the transmission timing of a retransmission packet for an initial transmission packet is kept constant. In the asynchronous HARQ scheme, a scheduler of a base station determines the transmission timing of a retransmission packet for an initial transmission packet.

The HARQ may be classified into an adaptive HARQ and a non-adaptive HARQ according to whether the amount and positions of allocated resources are varied. The adaptive HARQ is a scheme in which the amount and positions of allocated resources are varied, and the non-adaptive HARQ is a scheme in which the amount and positions of allocated resources are fixed.

By properly combining the synchronous and asynchronous HARQ schemes and the adaptive and non-adaptive HARQ schemes together, and employing low signaling overhead, a high scheduling gain and a high-speed data transmission effect are achieved. For example, a mobile communication system may adopt an adaptive asynchronous HARQ for downlink data transmission and the synchronous HARQ for uplink data transmission.

In order to reduce signaling overhead resulting from control signals such as resource allocation information, it may be effective to employ a synchronous non-adaptive HARQ scheme in which retransmission timing and the amount and positions of allocated resources are not varied. However, in a case that signaling overhead is not considered, it may be rather effective to employ asynchronous adaptive HARQ scheme with scheduling gain.

According to a conventional method, a base station and a mobile station determine timing in which wireless signals such as data packets are transmitted or received according to a fixed wireless signal processing time T_{proc} for each mobile station.

This method can provide rapid transmission service for mobile stations having low wireless signal processing time T_{proc}, namely mobile stations having excellent packet processing performance. However, there is no method for the base station to perform control of delaying packet transmission timing according to a control and allocation scheme of radio resources.

That is, according to the conventional method, in the environment where mobile stations that have the same or different processing times of wireless signals such as data packets are mixed, a scheduler of the base station depends on wireless signal processing capability of the mobile station. Therefore, in a case that the base station determines scheduling timing for transmitting wireless signals such as data packets, it should unconditionally depend on wireless signal processing capability of the mobile station. Due to this, the conventional method does not provide scheduling control such as delaying a frame location in which a resource is allocated by scheduling wireless signals such as data packets. Therefore, there is a problem that it is impossible to adjust a scheduling location for transmitting a wireless signal according to the radio channel environment, the radio resource availability, the quality of service (QoS), etc. That causes a problem that it is impossible to control a frame location transmission and resource allocation of the wireless signal in connection with the mobile station's wireless signal processing capability recognized by the base station.

### SUMMARY OF THE INVENTION

The present invention has been made in an effort to provide a communication method for base stations and mobile stations for managing radio resources more flexibly and efficiently as necessary.

An exemplary embodiment of the present invention provides a method for a mobile station to communicate with a base station, including: receiving a first control message including information on transmitting/receiving timing from the base station; and transmitting a second control message according to the transmitting/receiving timing to the base station.

Information on the transmitting/receiving timing may correspond to a frame offset.

Transmitting the second control message may include: determining a frame index for transmitting the second control message according to the frame offset; and transmitting the second control message at a frame corresponding to the frame index to the base station.

The first message may correspond to a downlink resource allocation message, and the second message may correspond to a feedback for a downlink packet.

The first message may correspond to one of a service connection request message, a service change request message, a service connection response message, and a service change response message.

The second message may correspond to a feedback for a downlink packet or a feedback for an uplink packet.

The first message may correspond to a response message for a random access initial access request message or a resource allocation request message.

The first message may correspond to a resource allocation information message and the second message may correspond to a ranging request message.

Another embodiment of the present invention provides a method for a base station to communicate with a mobile station, including: determining a transmitting/receiving timing for the mobile station; transmitting the first control message including information on the transmitting/receiving timing to the mobile station; and receiving the second control message according to the transmitting/receiving timing from the mobile station.

Information on the transmitting/receiving timing may correspond to a frame offset.

Receiving the second control message may comprise receiving the second control message in a frame corresponding to a frame index determined according to the frame offset.

Transmitting the first control message may comprise: applying a masking indicator including the transmitting/receiving timing information to a cyclic redundancy check (CRC) which is made based on information field values of the first control message; and transmitting the first control message to the mobile station.

Yet another embodiment of the present invention provides a method for a mobile station to communicate with a base station, comprising: receiving a first frame offset from the base station; determining a first frame index by using the first frame offset; and transmitting an uplink packet in a frame corresponding to the first frame index to the base station.

The method may further comprises: receiving a second frame offset from the base station; and receiving a feedback corresponding to the uplink packet in a frame corresponding to a second frame index which is determined by using the second frame offset.

The first frame offset and the second frame offset may be included in an uplink resource allocation message which the base station transmits to the mobile station.

The method may further comprise: if the feedback is negative, determining a third frame index by using the first frame offset; and retransmitting the uplink packet in a frame corresponding to the third frame index to the base station.

An uplink resource allocation message may be received in a frame corresponding to a fourth frame index.

Determining the first frame index may comprise: determining the first frame index by using the fourth frame index, the number of subframes which one frame includes, and the first frame offset.

Determining the third frame index may comprise: determining the third frame index by using the second frame index, the number of subframes which one frame includes, and the first frame offset.

Another embodiment of the present invention provides a method for a base station to communicate with a mobile station, comprising: transmitting a first frame offset to the mobile station; and receiving an uplink packet from the mobile station in a frame corresponding to the first frame index determined by using the first frame offset.

The method may further comprise: transmitting a second frame offset to the mobile station; determining a second frame index by using the second frame offset; and transmitting a feedback corresponding to the uplink packet to the mobile station in a frame corresponding to the second frame index. The method may further comprise, if the feedback is negative, re-receiving the uplink packet from the mobile station in a frame corresponding to a third frame index determined by using the first frame offset.

Determining the second frame index may comprise determining the second frame index by using the first frame index, the number of subframes which one frame includes, and the second frame offset.

### BRIEF DESCRIPTION OF THE DRAWINGS

FIG. 1 illustrates a communication frame of a frequency division duplex (FDD) scheme in the conventional art.

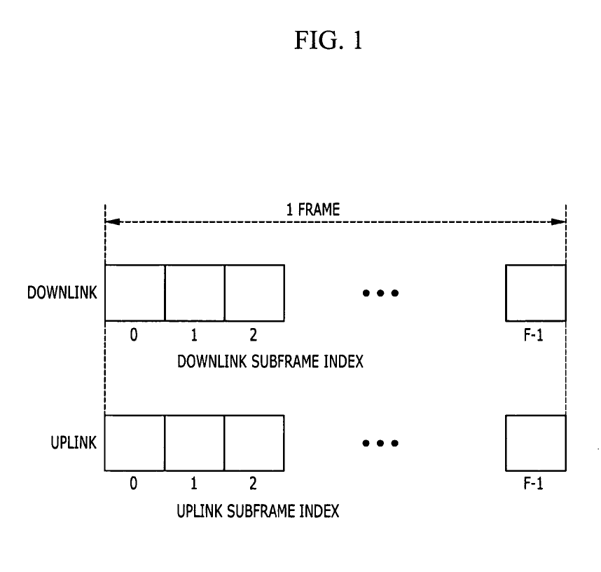

FIG. 2 illustrates a communication frame of a time division duplex (TDD) scheme in the conventional art.

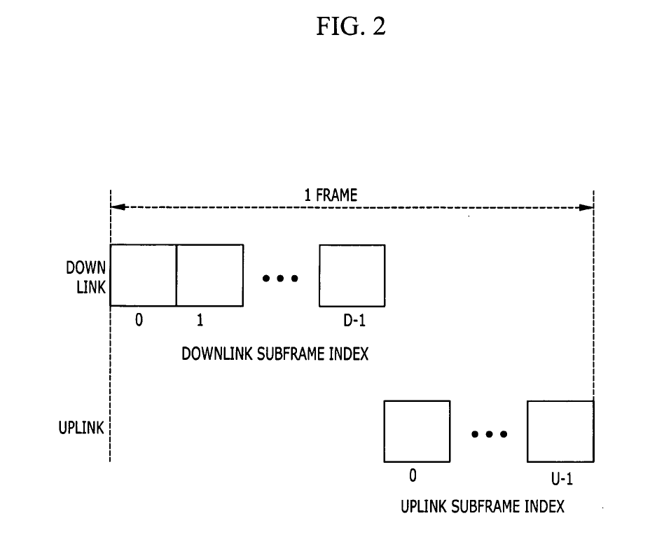

FIG. 3 is a flowchart showing a transmitting/receiving timing information providing method according to an exemplary embodiment of the present invention.

FIG. 4 is a flowchart showing a transmitting/receiving timing information providing method according to another exemplary embodiment of the present invention.

FIG. 5 is a flowchart illustrating a downlink data communication method according to an exemplary embodiment of the present invention.

FIG. 6 is a flowchart illustrating an uplink data communication method according to an exemplary embodiment of the present invention.

FIG. 7 is a flowchart illustrating a downlink data communication method according to another exemplary embodiment of the present invention.

FIG. 8 is a flowchart illustrating an uplink data communication method according to another exemplary embodiment of the present invention.

FIG. 9 is a flowchart illustrating a communication method including providing transmitting/receiving timing information according to an exemplary embodiment of the present invention.

FIG. 10 is a flowchart illustrating a communication method including providing transmitting/receiving timing information according to an exemplary embodiment of the present invention.

FIG. 11 is a flowchart illustrating a communication method including providing transmitting/receiving timing information according to an exemplary embodiment of the present invention.

FIG. 12 is a flowchart illustrating a communication method including providing transmitting/receiving timing information according to an exemplary embodiment of the present invention.

FIG. 13 shows FDD UL HARQ timing in a short term interval transmitting/receiving method according to an exemplary embodiment of the present invention.

FIG. 14 shows FDD UL HARQ timing in a long term interval transmitting/receiving method according to an exemplary embodiment of the present invention.

FIG. 15 shows FDD UL HARQ timing in a long term interval transmitting/receiving method according to an exemplary embodiment of the present invention.

FIG. 16 shows FDD UL HARQ timing in a long term interval transmitting/receiving method according to an exemplary embodiment of the present invention.

FIG. 17 shows TDD UL HARQ timing in a short term interval transmitting/receiving method according to an exemplary embodiment of the present invention.

FIG. 18 shows TDD UL HARQ timing in a long term interval transmitting/receiving method according to an exemplary embodiment of the present invention.

FIG. 19 shows TDD UL HARQ timing in a long term interval transmitting/receiving method according to an exemplary embodiment of the present invention.

FIG. 20 shows TDD UL HARQ timing in a long term interval transmitting/receiving method according to an exemplary embodiment of the present invention.

FIG. 21 shows FDD DL HARQ timing in a short term interval transmitting/receiving method according to an exemplary embodiment of the present invention.

FIG. 22 shows FDD DL HARQ timing in a long term interval transmitting/receiving method according to an exemplary embodiment of the present invention.

FIG. 23 shows TDD DL HARQ timing in a short term interval transmitting/receiving method according to an exemplary embodiment of the present invention.

FIG. 24 shows TDD DL HARQ timing in a long term interval transmitting/receiving method according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements.

In this specification, a mobile station (MS) may designate a terminal, an advanced mobile station (AMS), a mobile terminal (MT), a subscriber station (SS), a portable subscriber station (PSS), user equipment (UE), an access terminal (AT), etc., and may include the entire or partial functions of the mobile terminal, the subscriber station, the portable subscriber station, the user equipment, etc.

In this specification, a base station (BS) may designate an access point (AP), an advanced base station (ABS), a radio access station (RAS), a Node B, a base transceiver station (BTS), a mobile multihop relay (MMR)-BS, etc., and may include the entire or partial functions of the access point, the radio access station, the node B, the base transceiver station, the MMR-BS, etc.

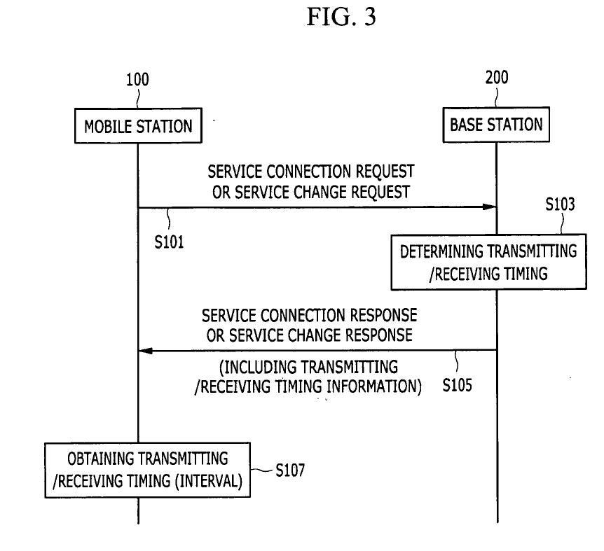

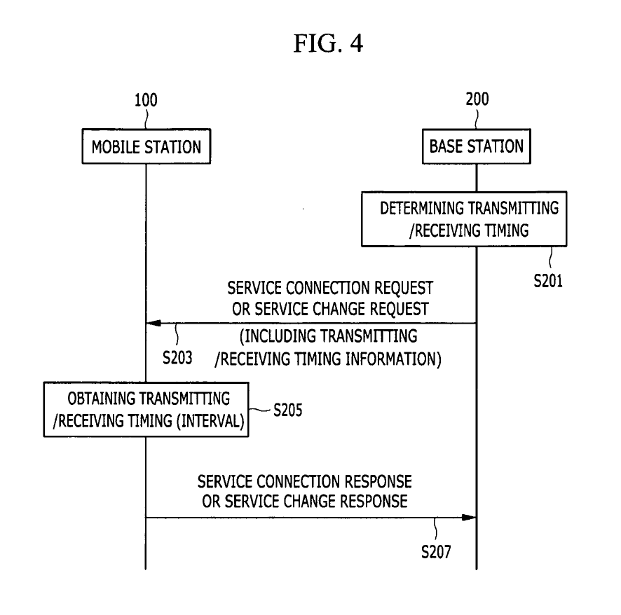

Next, referring to FIG. 3 and FIG. 4, a method for a base station 200 to provide transmitting/receiving timing information to a mobile station 100 will be described according to an exemplary embodiment of the present invention.

FIG. 3 is a flowchart showing a transmitting/receiving timing information providing method according to an exemplary embodiment of the present invention.

As shown in FIG. 3, the mobile station 100 transmits a service connection request message or a service change request message to the base station 200 in step S101.

The base station 200 determines transmitting/receiving timing in step S103, and transmits a service connection response message or a service change response message including information on the determined transmitting/receiving timing to the mobile station 100 in step S105. At this time, transmitting/receiving timing represents a short term interval or a long term interval. A short term interval transmitting/receiving method corresponds to a method by which scheduling timing for transmitting/receiving a wireless signal is determined depending only on wireless signal processing time of data packets of a mobile station. A long term interval transmitting/receiving method corresponds to a method by which determination of transmitting/receiving timing depends not only on the mobile station's wireless signal processing time, but the base station forcibly directs transmitting/receiving timing information to the mobile station to determine a point of time for transmitting/receiving a wireless signal according to the transmitting/receiving timing so that the base station can determine scheduling timing when the base station transmits/receives wireless signals to/from the mobile station.

The mobile station 100 obtains transmitting/receiving timing through transmitting/receiving timing information included in the service connection response message or the service change response message in step S107.

FIG. 4 is a flowchart showing a transmitting/receiving timing information providing method according to another exemplary embodiment of the present invention.

As shown in FIG. 4, the base station 200 determines transmitting/receiving timing in step S201, and transmits, to the mobile station 100, the service connection request message or the service change request message including information on a determined transmitting/receiving timing in step S203.

The mobile station 100 obtains transmitting/receiving timing through transmitting/receiving timing information included in the service connection response message or the service change response message in step S205, and transmits a service connection response message or a service change response message to the base station 200 in step S207.

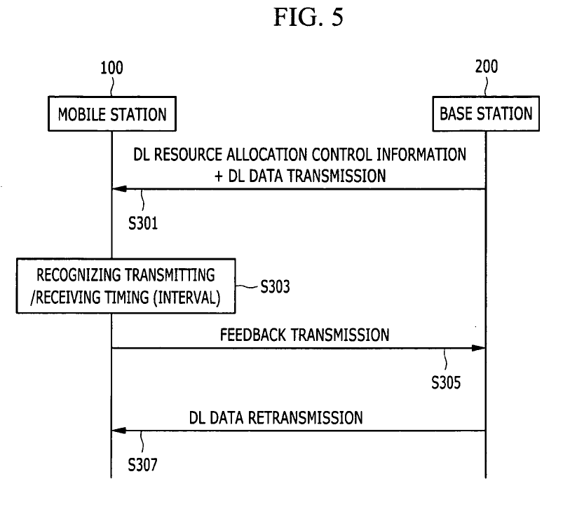

Next, referring to FIG. 5 to FIG. 12, communication method according to various exemplary embodiments of the present invention will be described.

FIG. 5 is a flowchart illustrating a downlink data communication method according to an exemplary embodiment of the present invention.

After service connection establishment or a service change process, the base station 200 transmits downlink resource allocation control information (MAP) in an l-th subframe of an i-th frame, and transmits a downlink HARQ packet in an m-th subframe of an i-th frame in step S301.

The mobile station 100 recognizes transmitting/receiving timing in step S303, determines a frame index j for transmitting a feedback according to recognized transmitting/receiving timing, and transmits a feedback for the received downlink HARQ packet in an n-th subframe of a j-th frame in step S305.

If this feedback is a negative response, the base station 200 retransmits the downlink HARQ packet in step S307.

According to an exemplary embodiment of the present invention, the frame indices i and j, the subframe indices l, m, and n can be determined as shown in Table 1 for FDD, and can be determined as shown in Table 2 for TDD. Table 1 shows FDD DL HARQ Timing.

TABLE 1

| field | Subframe index | frame index |
|---|---|---|
| DL resource | l | i |
| allocation | | |
| control signal | | |
| information | | |
| transmission | | |
| HARQ packet | m = l | i |
| transmission | | |
| HARQ feedback | n = ceil(m + F/2) mod F | $j = ( i + floor ( \frac{ceil ( m + F / 2 )}{F} + z ) mod F$ |

In Table 1, the ceil(x) function returns the smallest integer value greater than or equal to parameter x. The floor(x) function returns the greatest integer value less than or equal to parameter x. A mod B returns the remainder of division of A by B.

In Table 1, the downlink feedback frame offset z for the FDD transmission mode can be determined according to Equation 1.

$$z = \{ \begin{matrix}0 , & if ( ceil ( F / 2 ) - {N}_{TTI} \geq {T}_{proc} ) \\ 1 , & else\end{matrix} \qquad ( Equation 1 )$$

In Equation 1, N_{TTI}, represents the number of subframes occupied when transmitting a data burst as transmission time intervals (TTI) corresponding to the transmission time unit, namely the number of subframes over which a HARQ packet stretches. The TTI represents, in the form of the integer of subframes, a duration or an interval for which the physical layer's transmission of an encoded packet on the wireless interface (radio air interface) lasts.

However, as described above, in case the downlink feedback frame offset z is determined according to Equation 1, there is no method for the base station to perform control of delaying packet transmission timing according to the control and allocation scheme of radio resources.

Therefore, the mobile station 100 may determine the downlink feedback frame offset z of the FDD transmission mode according to transmitting/receiving timing information which is provided in the service connection establishment or service change process. A method for determining frame offsets according to transmitting/receiving timing information will be explained below.

Table 2 shows TDD DL HARQ timing.

TABLE 2

| Field | Subframe index | Frame index |
|---|---|---|
| DL resource | l | i |
| allocation | | |
| control signal | | |
| information | | |
| transmission | | |
| HARQ packet | m = l | i |
| transmission | | |
| HARQ feedback | For D > U, | j = (i + z) mod 4 |
| | $n = \{ \begin{matrix}0 , & for 0 \leq m < K \\ m - K , & for K \leq m < U + K \\ U - 1 , & for U + K \leq m < D\end{matrix}$ | |
| | For D ≦ U, n = m − K | |

In Table 2, the parameter K is a parameter that is determined according to the system capability such as the channel bandwidth and the number of subframes in TDD, and is used for obtaining a HARQ reference timing interval. A downlink HARQ reference timing interval represents an interval between a downlink subframe at which the downlink data burst is transmitted and a downlink subframe at which the HARQ feedback is transmitted. An uplink HARQ reference timing interval represents an interval between a downlink subframe at which uplink resource allocation information is transmitted and an uplink subframe at which the uplink data burst is transmitted.

In Table 2, the downlink feedback frame offset z of the TDD transmission mode can be determined according to Equation 2.

$$z = \{ \begin{matrix}0 , & if ( ( D - m - {N}_{TTI} + n ) \geq {T}_{proc} \\ 1 , & else\end{matrix} \qquad ( Equation 2 )$$

However, as described above, in case the downlink feedback frame offset z is determined according to Equation 2, there is no method for the base station to perform control of delaying packet transmission timing according to the control and allocation scheme of radio resources.

Therefore, the mobile station 100 may determine the downlink feedback frame offset z of TDD transmission mode according to the transmitting/receiving timing information which is provided in the service connection establishment or service change process. A method for determining frame offsets according to transmitting/receiving timing information will be explained below.

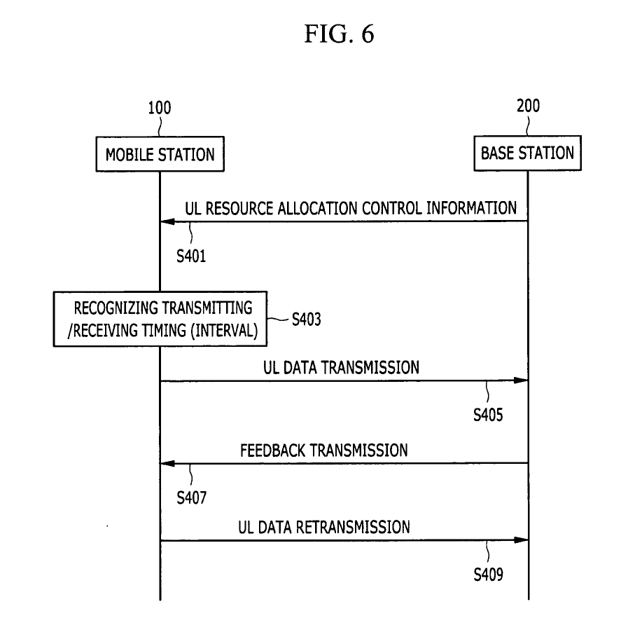

FIG. 6 is a flowchart illustrating an uplink data communication method according to an exemplary embodiment of the present invention.

After the service connection establishment or service change process, the base station 200 transmits the uplink resource allocation control information (MAP) at an l-th subframe of an i-th frame in step S401.

The mobile station 100 recognizes transmitting/receiving timing in step S403, determines a frame index j for transmitting a HARQ packet according to the recognized transmitting/receiving timing, and then transmits an uplink HARQ packet at an m-th subframe of a j-th frame in step S405.

The base station 200 transmits a feedback for a received uplink HARQ packet at an n-th subframe of a k-th frame to the mobile station 100 in step S407.

If this feedback is a negative response, the mobile station 100 retransmits an uplink HARQ packet at an m-th subframe of a p-th frame in step S409.

According to an exemplary embodiment of the present invention, the frame indices i, j, k, and p and the subframe indices l, m, and n can be determined as shown in Table 3 for FDD, and can be determined as shown in Table 4 for TDD.

Table 3 shows FDD UL HARQ timing.

TABLE 3

| Field | Subframe index | Frame index |
|---|---|---|
| UL resource | l | i |
| allocation | | |
| control signal | | |
| information | | |
| transmission | | |
| HARQ packet transmission | m = ceil(l + F/2) mod F | $j = ( i + floor ( \frac{ceil ( l + F / 2 )}{F} ) + v ) mod 4$ |
| HARQ feedback | n = l | $k = ( j + floor ( \frac{m + F / 2}{F} ) + w ) mod 4$ |
| HARQ packet retransmission | m | $p = ( k + floor ( \frac{ceil ( l + F / 2 )}{F} ) + v ) mod 4$ |

In Table 3, the uplink data packet transmission frame offset v and the uplink feedback frame offset w of the FDD transmission mode can be determined according to Equation 3.

$$v = \{ \begin{matrix}0 , & if ( ( ceil ( F / 2 ) - 1 ) \geq {T}_{proc} ) \\ 1 , & else\end{matrix} \\ w = \{ \begin{matrix}0 , & if ( ( floor ( F / 2 ) - {N}_{TTI} ) \geq {T}_{proc} ) \\ 1 , & else\end{matrix} \qquad ( Equation 3 )$$

However, as described above, in case the uplink data packet transmission frame offset v and the uplink feedback frame offset w are determined according to Equation 3, there is no method for the base station to perform control of delaying packet transmission timing according to the control and allocation scheme of radio resources.

Therefore, the mobile station 100 may determine the uplink feedback frame offset z of the FDD transmission mode according to transmitting/receiving timing information which is provided in the service connection establishment or service change process. A method for determining frame offsets according to transmitting/receiving timing information will be explained below.

Table 4 shows TDD UL HARQ timing.

TABLE 4

| Fields | Subframe index | Frame index |
|---|---|---|
| UL resource | l | i |
| allocation | | |
| control signal | | |
| information | | |
| transmission | | |
| HARQ packet | For D ≧ U, | j = (i + v) mod 4 |
| transmission | $m = \{ \begin{matrix}0 , & for 0 \leq l < K \\ l - K , & for K \leq l < U + K \\ U - 1 , & for U + K \leq l < D\end{matrix}$ | |
| | For 1 < D < U, | |
| | $m = \{ \begin{matrix}0 , … , or l - K , & for l = 0 \\ l - K , & for 0 < l < D - 1 \\ l - K , … , or U - 1 , & for l = D - 1\end{matrix}$ | |
| | For D = 1, | |
| | m = 0, . . . , U − 1 | |
| HARQ feedback | n = l | k = (j + 1 + w) mod 4 |
| HARQ packet | m | p = (k + v) mod 4 |
| retransmission | | |

In Table 4, the uplink data packet transmission frame offset v and the uplink feedback frame offset w of the TDD transmission mode can be determined according to Equation 4.

$$v = \{ \begin{matrix}0 , & if ( ( D - l - 1 + m ) \geq {T}_{proc} ) \\ 1 , & else\end{matrix} \\ w = \{ \begin{matrix}0 , & if ( ( U - m - {N}_{TTI} + l ) \geq {T}_{proc} \\ 1 , & else\end{matrix} \qquad ( Equation 4 )$$

However, as described above, in case the uplink data packet transmission frame offset v and the uplink feedback frame offset w are determined according to Equation 4, there is no method for the base station to perform control of delaying packet transmission timing according to the control and allocation scheme of radio resources.

Therefore, the mobile station 100 may determine the uplink feedback frame offset z of the TDD transmission mode according to transmitting/receiving timing information which is provided in the service connection establishment or service change process. A method for determining frame offsets according to transmitting/receiving timing information will be explained below.

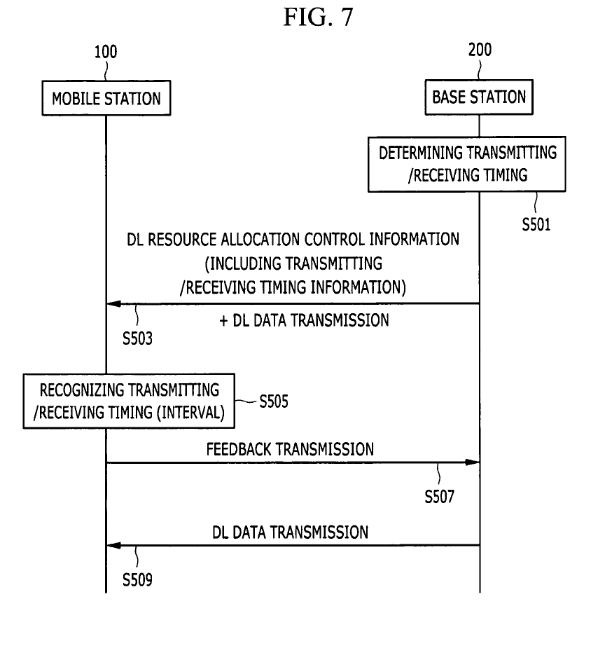

FIG. 7 is a flowchart illustrating a downlink data communication method according to another exemplary embodiment of the present invention.

First, the base station 200 determines transmitting/receiving timing in step S501.

The base station 200 transmits downlink resource allocation control information (MAP) including transmitting/receiving timing information at an l-th subframe of an i-th frame, and transmits a downlink HARQ packet at an m-th subframe of the i-th frame in step S503.

The mobile station 100 recognizes transmitting/receiving timing in step S505, determines a frame index j for transmitting a feedback according to the recognized transmitting/receiving timing, and then transmits a feedback for a received downlink HARQ packet at an n-th subframe of a j-th frame in step S507.

If this feedback is a negative response, the base station 200 retransmits the downlink HARQ packet in step S509.

According to an exemplary embodiment of the present invention, the frame indices i and j and the subframe indices l, m, and n can be determined as shown in Table 1 for FDD, and can be determined as shown in Table 2 for TDD. A method for determining frame offsets according to the transmitting/receiving timing information will be described below.

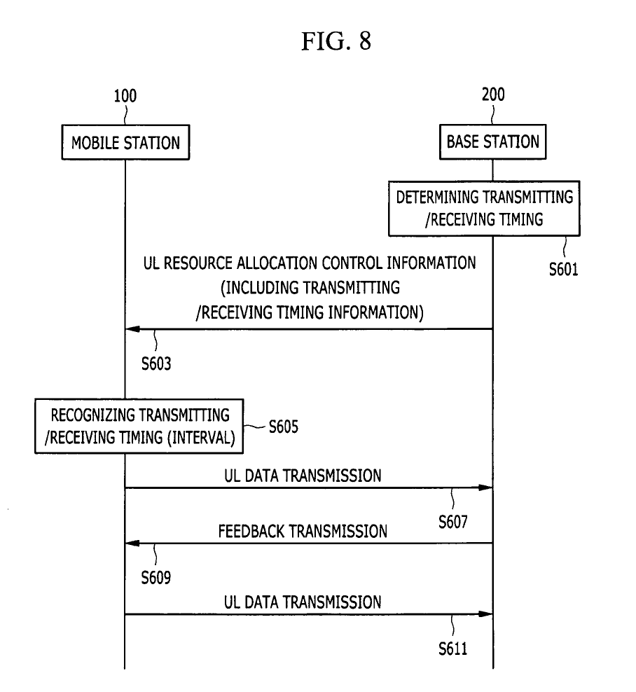

FIG. 8 is a flowchart illustrating an uplink data communication method according to another exemplary embodiment of the present invention.

First, the base station 200 determines transmitting/receiving timing in step S601.

The base station 200 transmits uplink resource allocation control information (MAP) including transmitting/receiving timing information at an l-th subframe of an i-th frame in step S603.

The mobile station 100 recognizes the transmitting/receiving timing in step S605, determines a frame index j for transmitting a HARQ packet according to the recognized transmitting/receiving timing, and then transmits an uplink HARQ packet at an m-th subframe of a j-th frame in step S607.

The base station 200 transmits a feedback for a received uplink HARQ packet at an n-th subframe of a k-th frame to the mobile station 100 in step S609.

If this feedback is a negative response, the mobile station 100 retransmits the uplink HARQ packet at an m-th subframe of a p-th frame in step S611.

According to an exemplary embodiment of the present invention, the frame indices i, j, k and p and subframe indices l, m, and n can be determined as shown in Table 3 for FDD, and can be determined as shown in Table 4 for TDD. A method for determining frame offsets according to the transmitting/receiving timing information will be described below.

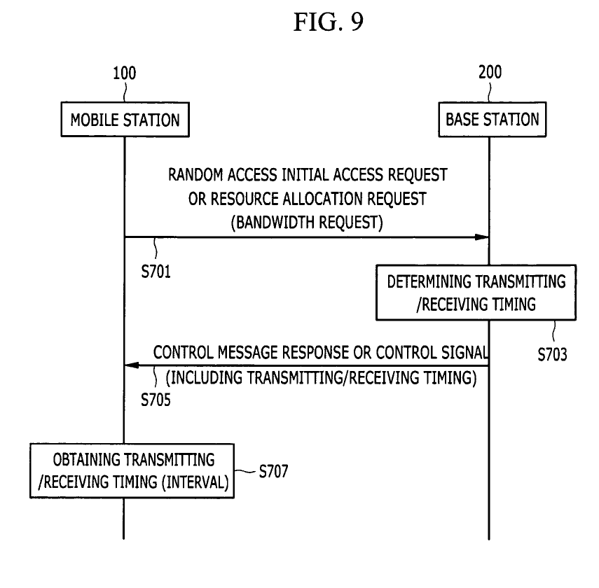

Next, referring to FIG. 9 to FIG. 12, method will be described for dynamically controlling transmitting/receiving timing for control messages as necessary through transmitting/receiving timing information by notifying a control message including transmitting/receiving timing information to a mobile station according to various exemplary embodiments of the present invention.

In particular, in case the transmitting/receiving timing information is provided through the control message, transmitting/receiving timing information can be included not only in the control message, but also in a control information signal (MAP) as described above. For example, transmitting/receiving timing information can be provided by adding a transmitting/receiving timing information field to the control information signal (MAP) or adding a masking indicator when CRC masking.

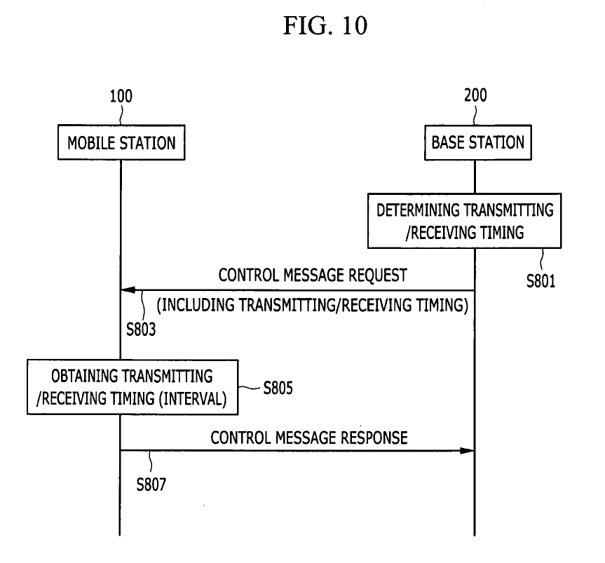

In a case that it is necessary for the mobile station 100 to provide transmitting/receiving timing information for a resource allocation control signal or a resource allocation information control message resulting from initial access of the wireless link for the initial network access or a resource allocation bandwidth request of the mobile station 100 before the base station 200 obtains a wireless signal processing capability including a wireless signal processing time of the mobile station 100, these methods can be used. Also, in case that it is necessary for the base station 200 to provide transmitting/receiving timing information when the base station 200 and the mobile station 100 transmit or receive control messages, these methods can be used. FIG. 9 and FIG. 10 show these methods.

FIG. 9 is a flowchart illustrating a communication method including providing transmitting/receiving timing information according to an exemplary embodiment of the present invention.

As represented in FIG. 9, in case the mobile station 100 tries the initial network access or requests the resource allocation bandwidth before the base station 200 obtains the wireless signal processing capability including the wireless signal processing time of the mobile station 100, the base station 200 cannot know the wireless signal processing time of the mobile station 100. Therefore, in case there is an access request via a random access channel for the mobile station 100's initial access of the wireless link or in case there is a resource allocation bandwidth request from the mobile station 100 of which the wireless signal processing capability the base station 200 cannot know in step S701, the base station 200 determines transmitting/receiving timing in step S703. Then, the base station 200 conveys a control message, a control information signal (MAP), etc., including the transmitting/receiving timing information to the mobile station 100 in step S705. The mobile station 100 obtains the transmitting/receiving timing so that the mobile station 100 can transmit or receive next control messages in the determined transmitting/receiving timing in step S707.

FIG. 10 is a flowchart illustrating a communication method including providing transmitting/receiving timing information according to an exemplary embodiment of the present invention.

As illustrated in FIG. 10, in order to transmit or receive control messages before the base station 200 obtains the wireless signal processing capability including the wireless signal processing time of the mobile station 100, the base station 200 determines transmitting/receiving timing in step S801. The base station 200 provides a control message including transmitting/receiving timing information to the mobile station 100 in step S803. The mobile station 100 obtains the transmitting/receiving timing in step S805, so the mobile station 100 transmits or receives the next control message at the determined transmitting/receiving timing in step S807. At this time, determination of timing needed in the HARQ operation is performed through the obtained transmitting/receiving timing information.

In case the transmitting/receiving timing information is established, for the HARQ operation until the base station 200 obtains the wireless signal processing capability such as the wireless signal processing time of the mobile station 100, the mobile station 100 can keep transmitting/receiving timing information provided by the base station 200.

In the other hand, the control message can correspond to a MAC control message, and a control information signal can correspond to a MAP or an A-MAP.

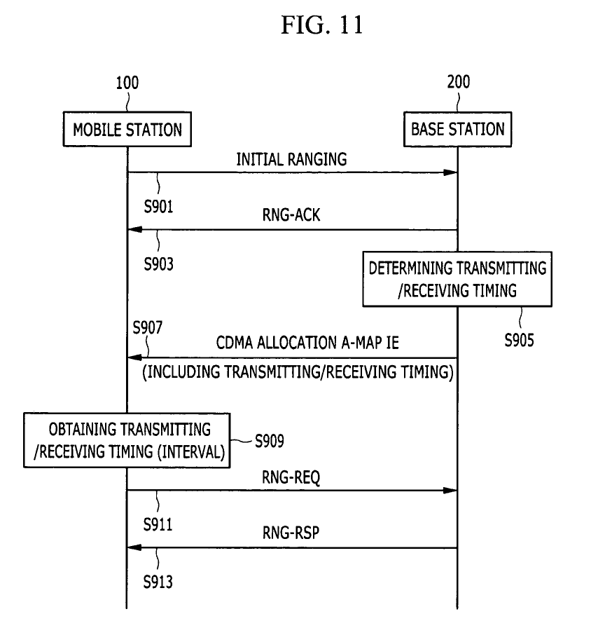

FIG. 11 is a flowchart illustrating a communication method including providing transmitting/receiving timing information according to an exemplary embodiment of the present invention.

As illustrated in FIG. 11, in case the mobile station 100 tries the wireless link initial access via the initial ranging process before obtaining the wireless signal processing capability including the wireless signal processing time in step S901, the base station 200 broadcasts an RNG-ACK message after successfully obtaining an initial ranging code in step S903. Then, the base station 200 determines transmitting/receiving timing for a corresponding mobile station 100 in step S905, after which the base station 200 transmits a CDMA allocation A-MAP IE corresponding to a control signal including resource allocation information for uplink data transmission and transmitting/receiving timing information to the mobile station 100 in step S907. The mobile station 100 which received the CDMA allocation A-MAP IE control signal obtains transmitting/receiving timing information in step S909, and transmits a ranging request MAC control message (RNG-REQ MAC control message) corresponding to a control message in an uplink resource allocation region at the obtained transmitting/receiving timing to the base station in step S911. As a response, the base station 200 transmits a ranging response MAC control message (RNG-RSP MAC control message) corresponding to a control message to the mobile station 100 in step S913. At this time, the above-obtained transmitting/receiving timing information can be used in order to determine timing for transmitting or receiving the HARQ packet and HARQ feedback in connection with HARQ operation of RNG-REQ and RNG-RSP MAC control messages corresponding to control messages.

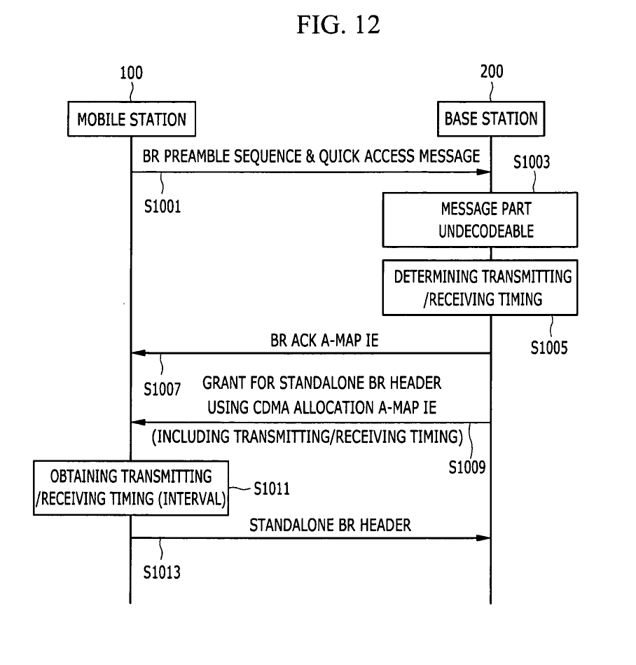

FIG. 12 is a flowchart illustrating a communication method including providing transmitting/receiving timing information according to an exemplary embodiment of the present invention.

First, in the bandwidth request (BR) process corresponding to the band allocation request process for uplink data transmission, the mobile station 100 transmits a BR preamble sequence and a quick access message to the base station 200 in step S1001.

In case the base station 200 successfully decodes the BR preamble sequence transmitted by the mobile station 100 but does not decode a message part (BR message part) of the quick access message including a station ID (STID) corresponding to a classification identifier of the mobile station 100 in step S1003, the base station 200 cannot recognize the wireless signal processing time of the corresponding mobile station 100, so the base station 200 determines transmitting/receiving timing for the corresponding mobile station 100 in step S1005, transmits a BR ACK A-MAP IE to the mobile station 100 in step S1007, and transmits a CDMA allocation A-MAP IE corresponding to a control signal including transmitting/receiving timing information and uplink resource allocation information to the mobile station 100 in step S1009. The mobile station 100 which receives the CDMA allocation A-MAP IE control signal obtains transmitting/receiving timing information in step S1011, and transmits a BR header to the base station 200 in an uplink resource allocation region at the transmitting/receiving timing obtained through the transmitting/receiving timing information as a bandwidth request message for uplink data transmission in step S1013. The BR header includes an STID of the mobile station 100 and a required resource allocation volume (bandwidth), and the base station 200 can recognize the wireless signal processing capability such as the wireless signal processing time of the mobile station 100 which is negotiated previously through the included STID information.

Next, referring to Table 5 to Table 10, a method for determining frame offsets according to transmitting/receiving timing information will be described. This transmitting/receiving timing information can be included in control messages such as the service connection request message, the service change request message, the service connection response message, the service change response message, the downlink resource allocation control information, the uplink resource allocation control information, and the CDMA allocation A-MAP IE. Also, transmitting/receiving timing information can be included in other messages.

Table 5 shows transmitting/receiving timing information according to an exemplary embodiment of the present invention.

TABLE 5

| | Size in | |
|---|---|---|
| Syntax | bits | Description/Notes |
| . . . | . . . | . . . |
| Transmitting/receiving | 1 | Indicates frame offset value (z) |
| timing information | | 0b0: not applicable |
| (frame offset indicator) | | 0b1: z is set to 1 |
| . . . | . . . | . . . |

As shown in Table 5, 1 bit of a frame offset indicator can be used as transmitting/receiving timing information. In this case, the frame offset indicator equal to 0 may represent the downlink feedback frame offset (z)=0, and the frame offset indicator equal to 1 may represent the downlink feedback frame offset (z)=1.

Table 6 shows transmitting/receiving timing information according to another exemplary embodiment of the present invention.

TABLE 6

| | Size in | |
|---|---|---|
| Syntax | bits | Description/Notes |
| . . . | . . . | . . . |
| Transmitting/receiving | 1 | Indicates frame offset value (w) |
| timing information | | 0b0: not applicable |
| (frame offset indicator) | | 0b1: w is set to 1 |
| . . . | . . . | . . . |

As shown in Table 6, 1 bit of a frame offset indicator can be used as transmitting/receiving timing information. In this case, the frame offset indicator equal to 0 can represent the uplink feedback frame offset (w)=0, and the frame offset indicator equal to 1 can represent the uplink feedback frame offset (w)=1.

Table 7 shows transmitting/receiving timing information according to another exemplary embodiment of the present invention.

TABLE 7

| | Size in | |
|---|---|---|
| Syntax | bits | Description/Notes |
| . . . | . . . | . . . |
| Transmitting/receiving | 2 | Indicates frame offset value (v and w) |
| timing information | | 0b00: not applicable |
| (frame offset indicator) | | 0b01: w is set to 1 |
| | | 0b10: v is set to 1 |
| | | 0b11: v and w is set to 1, respectively |
| . . . | . . . | . . . |

As shown in Table 7, 2 bits of a frame offset indicator can be used as transmitting/receiving timing information. In this case, the upper 1 bit of the frame offset indicator can represent the uplink data packet transmission frame offset v, and the lower 1 bit of the frame offset indicator can represent the uplink feedback frame offset w.

Table 8 shows transmitting/receiving timing information according to another exemplary embodiment of the present invention.

TABLE 8

| | Size | |
|---|---|---|
| Syntax | in bits | Description/Notes |
| . . . | . . . | . . . |
| Transmitting/receiving | 1 | Indicates a value of a frame offset for |
| timing information | | determining transmitting/receiving |
| (frame offset indicator) | | timing. The frame offset designates a |
| | | DL HARQ feedback offset z, an UL |
| | | HARQ transmission offset v, an UL |
| | | HARQ feedback offset w, etc. |
| | | 0b0: does not apply transmitting/ |
| | | receiving timing information. |
| | | 0b1: all frame offsets (z, v, w) are set to |
| | | 1. |
| . . . | . . . | . . . |

As shown in Table 8, 1 bit of a frame offset indicator can be used as transmitting/receiving timing information. In this case, the frame offset indicator equal to 0 can represent that all frame offsets are set to 0, and the frame offset indicator equal to 1 can represent that all frame offsets are set to 1.

In the other hand, a method can be used in which a masking indicator including transmitting/receiving timing information is applied to a cyclic redundancy check (CRC) field generated based on information field (contents) values of the resource allocation control signal (MAP).

Table 9 shows an example of the masking indicator that can be used for the CRC generated based on information field (contents) values of the resource allocation control signal (MAP). In particular, a CRC which is masked in a CRC field for specific purpose will be called an MCRC.

TABLE 9

| Masking Indicator | Description |
|---|---|
| 0b0000 | MCRC is masked by 12-bit STID |
| 0b0001 | MCRC is masked by 12-bit RAID for Ranging |
| 0b0010 | MCRC is masked by 12-bit RAID for bandwidth |
| | request |

Table 10 shows an example of an additional masking indicator that can be used for the CRC generated based on information field (contents) values of the resource allocation control signal (MAP).

TABLE 10

| Masking Indicator | Description |
|---|---|
| 0b0011 | MCRC is masked by 12-bit STID for frame offset |
| | z for DL, v for UL |
| 0b0100 | MCRC is masked by 12-bit STID for frame offset |
| | w for UL |

Like Table 10, the base station 200 applies a masking indicator including transmitting/receiving timing information to a cyclic redundancy check (CRC) field generated based on information field (contents) values of the resource allocation control signal (MAP) so that the base station 200 can provide, to the mobile station 100, transmitting/receiving timing on whether transmitting/receiving is performed according to a short term interval or a long term interval. A method such as Table 10 provides a merit of no waste of radio resources.

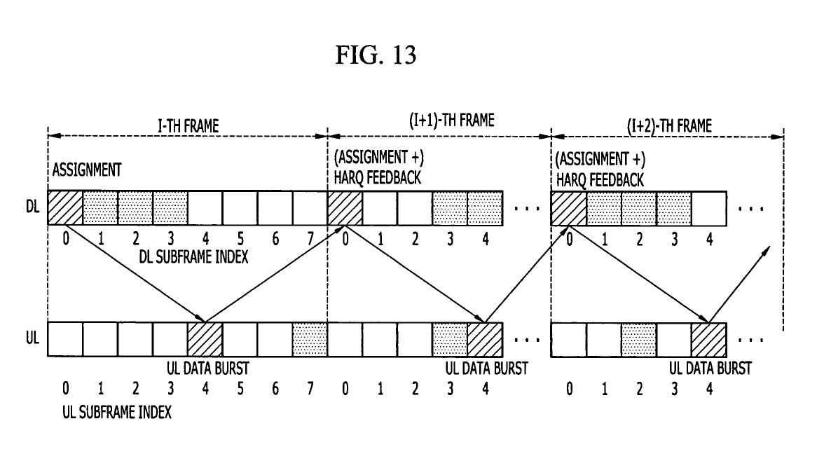

Next, referring to FIG. 13 to FIG. 24, HARQ timing according to an exemplary embodiment of the present invention will be described.

FIG. 13 shows FDD UL HARQ timing in a short term interval transmitting/receiving method according to an exemplary embodiment of the present invention. In particular, FIG. 13 shows FDD UL HARQ timing depending on the wireless signal processing time of the mobile station in a case of F=8, l=0, Tproc=3, v=0 and w=0.

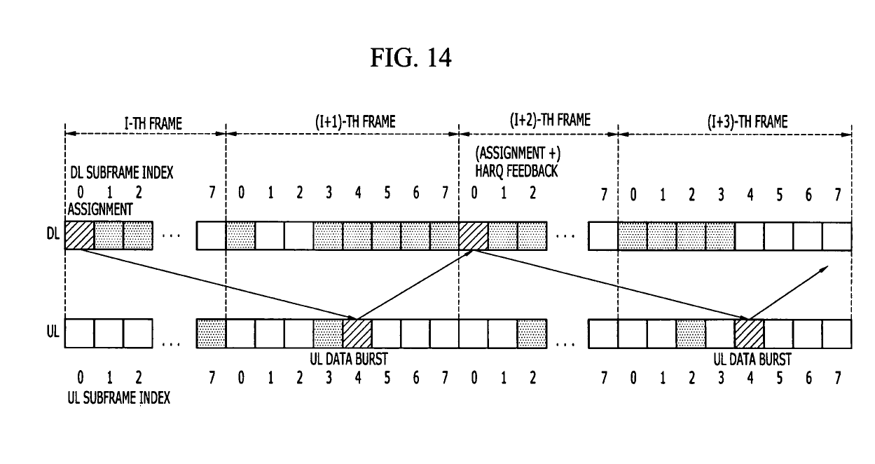

FIG. 14 shows FDD UL HARQ timing in a long term interval transmitting/receiving method according to an exemplary embodiment of the present invention. In particular, FIG. 14 shows FDD UL HARQ timing depending not on the wireless signal processing time of the mobile station, but on the forcibly directed offset value v in a case of F=8, l=0, Tproc=3, v=1, and w=0.

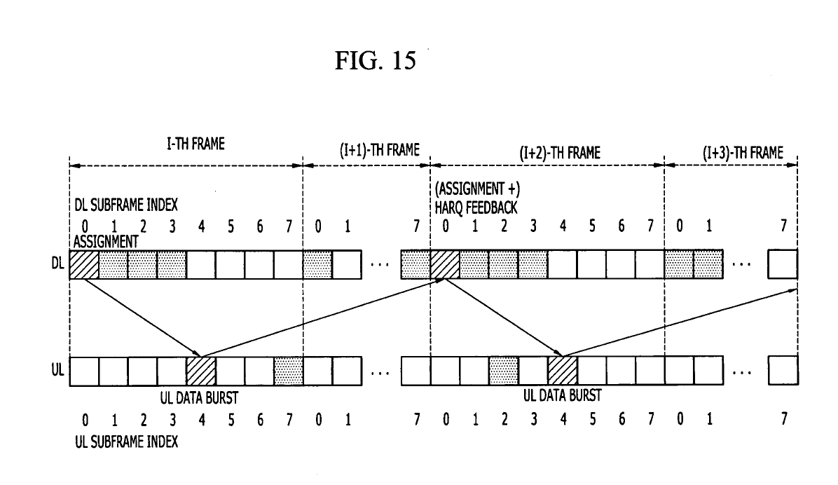

FIG. 15 shows FDD UL HARQ timing in a long term interval transmitting/receiving method according to an exemplary embodiment of the present invention. In particular, FIG. 15 shows FDD UL HARQ timing depending not on the wireless signal processing time of the mobile station, but on the forcibly directed offset value w in a case of F=8, l=0, Tproc=3, v=0, and w=1.

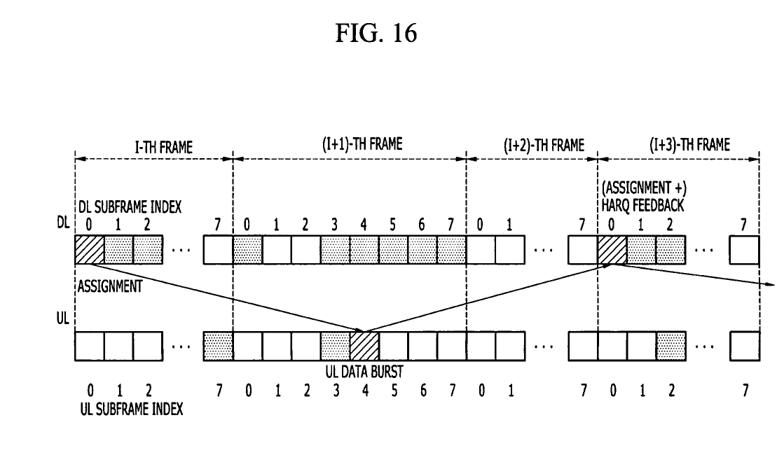

FIG. 16 shows FDD UL HARQ timing in a long term interval transmitting/receiving method according to an exemplary embodiment of the present invention. In particular, FIG. 16 shows FDD UL HARQ timing depending not on the wireless signal processing time of the mobile station, but on the forcibly directed offset values v and w in a case of F=8, l=0, Tproc=3, and v=w=1.

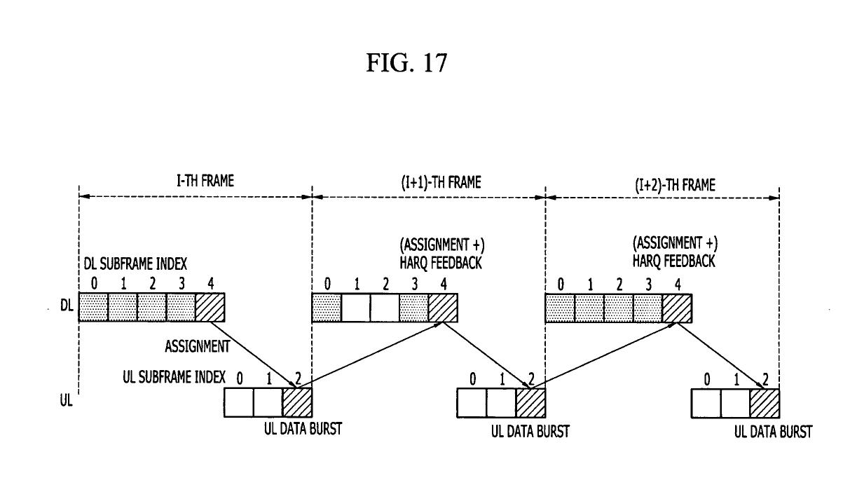

FIG. 17 shows TDD UL HARQ timing in a short term interval transmitting/receiving method according to an exemplary embodiment of the present invention. In particular, FIG. 17 shows TDD UL HARQ timing depending on the wireless signal processing time of the mobile station in a case of D:U=5:3, l=4, Tproc=2, v=0, and w=0.

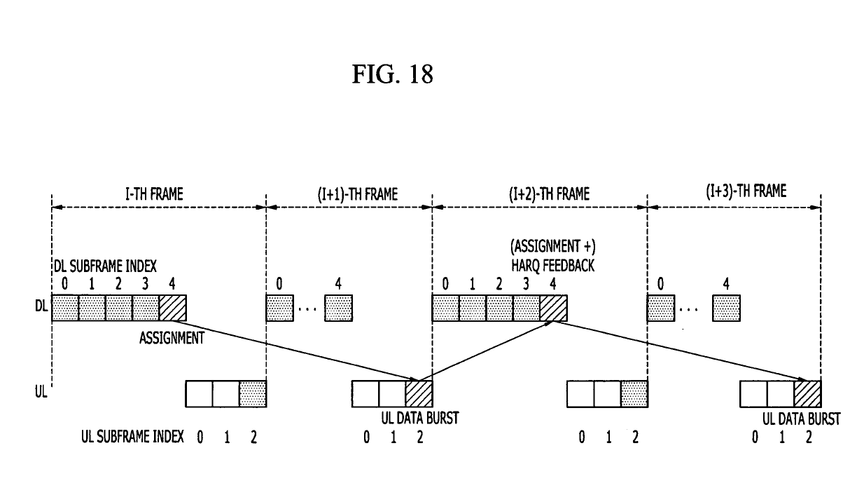

FIG. 18 shows TDD UL HARQ timing in a long term interval transmitting/receiving method according to an exemplary embodiment of the present invention. In particular, FIG. 18 shows TDD UL HARQ timing depending not on the wireless signal processing time of the mobile station, but on the forcibly directed offset value v in a case of D:U=5:3, l=4, Tproc=2, v=1, and w=0.

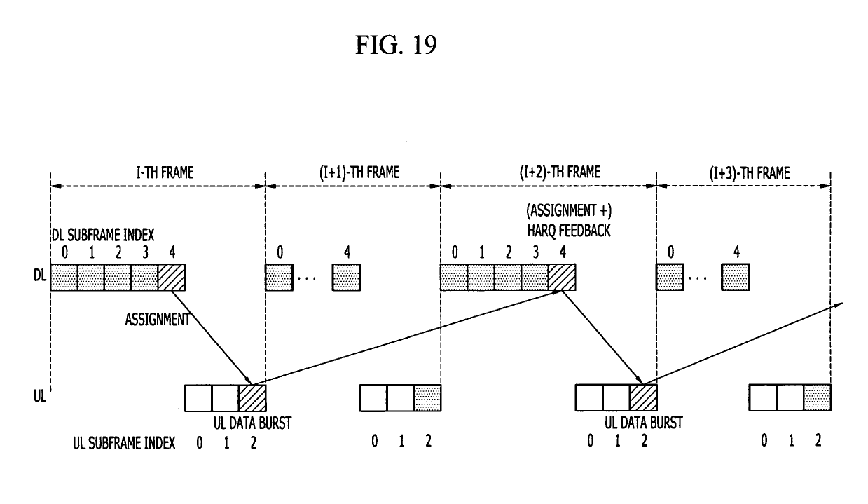

FIG. 19 shows TDD UL HARQ timing in a long term interval transmitting/receiving method according to an exemplary embodiment of the present invention. In particular, FIG. 19 shows TDD UL HARQ timing depending not on the wireless signal processing time of the mobile station, but on the forcibly directed offset value w in a case of D:U=5:3, l=4, Tproc=2, v=0, and w=1.

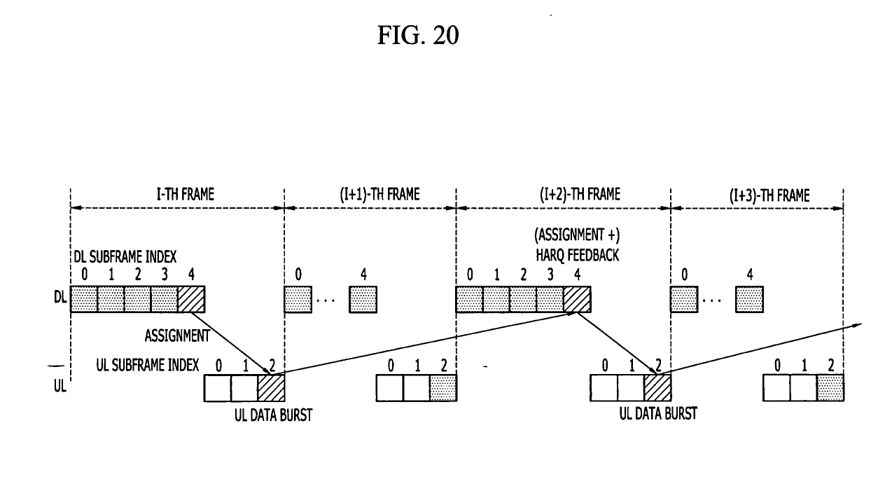

FIG. 20 shows TDD UL HARQ timing in a long term interval transmitting/receiving method according to an exemplary embodiment of the present invention. In particular, FIG. 20 shows TDD UL HARQ timing depending not on the wireless signal processing time of the mobile station, but on the forcibly directed offset values v and w in a case of D:U=5:3, l=4, Tproc=2, v=1, and w=1.

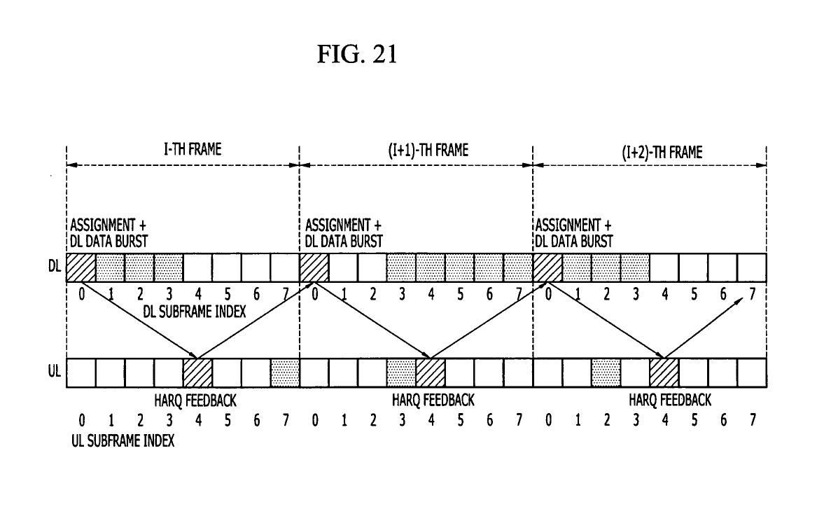

FIG. 21 shows FDD DL HARQ timing in a short term interval transmitting/receiving method according to an exemplary embodiment of the present invention. In particular, FIG. 21 shows FDD DL HARQ timing depending on the wireless signal processing time of the mobile station in a case of F=8, l=0, Tproc=3, and z=0.

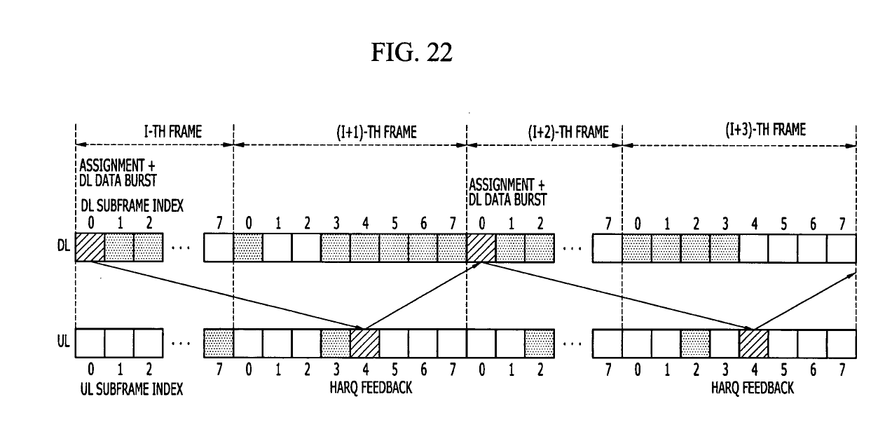

FIG. 22 shows FDD DL HARQ timing in a long term interval transmitting/receiving method according to an exemplary embodiment of the present invention. In particular, FIG. 22 shows FDD DL HARQ timing depending not on the wireless signal processing time of the mobile station, but on the forcibly directed offset value z in a case of F=8, l=0, Tproc=3, and z=1.

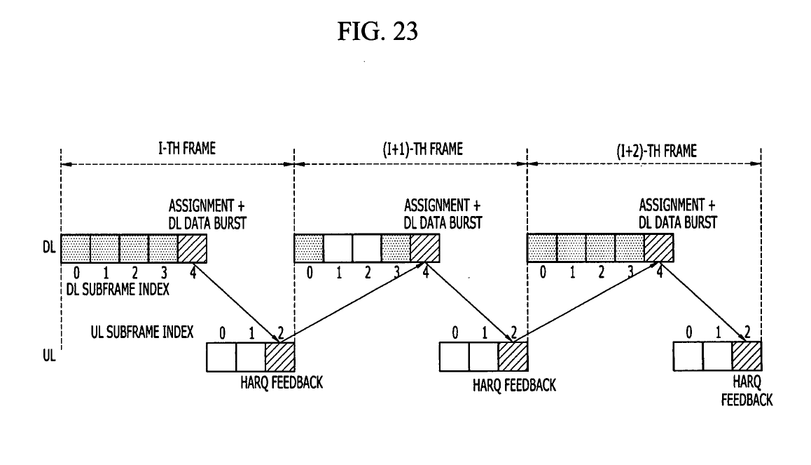

FIG. 23 shows TDD DL HARQ timing in a short term interval transmitting/receiving method according to an exemplary embodiment of the present invention. In particular, FIG. 23 shows TDD DL HARQ timing depending on the wireless signal processing time of the mobile station in a case of D:U=5:3, l=4, Tproc=2, and z=0.

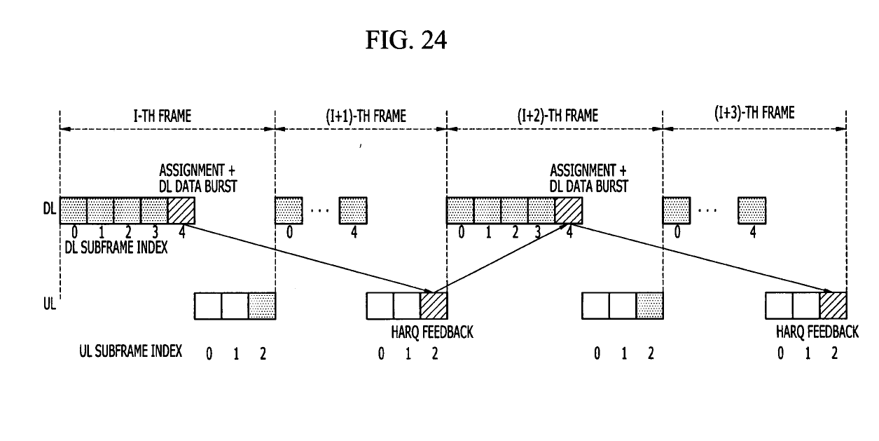

FIG. 24 shows TDD DL HARQ timing in a long term interval transmitting/receiving method according to an exemplary embodiment of the present invention. In particular, FIG. 24 shows TDD DL HARQ timing depending not on the wireless signal processing time of the mobile station, but on the forcibly directed offset value z in a case of D:U=5:3, l=4, Tproc=2, and z=1.

According to aspects of the present invention, it is possible to manage radio resources more flexibly and efficiently as necessary, by granting the base station the control authority so that the base station can control and determine transmitting/receiving timing of the mobile station as the short term interval, long term interval, etc., according to processing capability of the mobile station, various wireless environments, system environments, and user requirement service environments when wireless signals are transmitted or received between the base station and the mobile station.

The exemplary embodiments of the present invention are not implemented only by a device and/or method, but can be implemented through a program for realizing functions corresponding to the configuration of the exemplary embodiments of the present invention and a recording medium having the program recorded thereon. These implementations can be realized by the ordinarily skilled person in the art from the description of the above-described exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for a mobile station to communicate with a base station, comprising:
receiving a first control message including information on transmitting/receiving timing from the base station; and
transmitting a second control message according to the transmitting/receiving timing to the base station.

2. The method of claim 1, wherein information on the transmitting/receiving timing corresponds to a frame offset, and
wherein transmitting the second control message comprises:
determining a frame index for transmitting the second control message according to the frame offset; and
transmitting the second control message at a frame corresponding to the frame index to the base station.

3. The method of claim 2, wherein the first message corresponds to a downlink resource allocation message, and the second message corresponds to a feedback for a downlink packet.

4. The method of claim 2, wherein the first message corresponds to one of a service connection request message, a service change request message, a service connection response message, and a service change response message.

5. The method of claim 4, wherein the second message corresponds to a feedback for a downlink packet or a feedback for an uplink packet.

6. The method of claim 2, wherein the first message corresponds to a response message for a random access initial access request message or a resource allocation request message.

7. The method of claim 2, wherein the first message corresponds to a resource allocation information message and the second message corresponds to a ranging request message.

8. A method for a base station to communicate with a mobile station, comprising:
determining transmitting/receiving timing for the mobile station;
transmitting the first control message including information on the transmitting/receiving timing to the mobile station; and
receiving the second control message according to the transmitting/receiving timing from the mobile station.

9. The method of claim 8, wherein information on the transmitting/receiving timing corresponds to a frame offset,
wherein receiving the second control message comprises:
receiving the second control message in a frame corresponding to a frame index determined according to the frame offset.

10. The method of claim 9, wherein transmitting the first control message comprises:
applying a masking indicator including the transmitting/receiving timing information to a cyclic redundancy check (CRC) which is made based on information field values of the first control message; and
transmitting the first control message to the mobile station.

11. A method for a mobile station to communicate with a base station, comprising:
receiving a first frame offset from the base station;
determining a first frame index by using the first frame offset; and
transmitting an uplink packet in a frame corresponding to the first frame index to the base station.

12. The method of claim 11, further comprising:
receiving a second frame offset from the base station; and
receiving a feedback corresponding to the uplink packet in a frame corresponding to a second frame index which is determined by using the second frame offset.

13. The method of claim 12, wherein the first frame offset and the second frame offset are included in an uplink resource allocation message which the base station transmits to the mobile station.

14. The method of claim 13, further comprising:
if the feedback is negative, determining a third frame index by using the first frame offset; and
retransmitting the uplink packet in a frame corresponding to the third frame index to the base station.

15. The method of claim 14, wherein an uplink resource allocation message is received in a frame corresponding to a fourth frame index,
wherein determining the first frame index comprises:
determining the first frame index by using the fourth frame index, the number of subframes which one frame includes, and the first frame offset.

16. The method of claim 15, wherein determining the third frame index comprises:
determining the third frame index by using the second frame index, the number of subframes which one frame includes, and the first frame offset.

17. A method for a base station to communicate with a mobile station, comprising:
transmitting a first frame offset to the mobile station; and
receiving an uplink packet from the mobile station in a frame corresponding to the first frame index determined by using the first frame offset.

18. The method of claim 17, further comprising:
transmitting a second frame offset to the mobile station;
determining a second frame index by using the second frame offset; and
transmitting a feedback corresponding to the uplink packet to the mobile station in a frame corresponding to the second frame index.

19. The method of claim 18, further comprising:
if the feedback is negative, re-receiving the uplink packet from the mobile station in a frame corresponding to a third frame index determined by using the first frame offset.

20. The method of claim 19, wherein determining the second frame index comprises:
determining the second frame index by using the first frame index, the number of subframes which one frame includes, and the second frame offset.
